(19) United States
(12) Patent Application Publication
(10) Pub. No.: US 2021/0321844 A1
(43) Pub. Date: Oct. 21, 2021

(54) VACUUM FILTER HAVING PASS-THROUGH CATCH

(71) Applicant: SHOP VAC CORPORATION, Williamsport, PA (US)

(72) Inventors: Craig A. Seasholtz, Avis, PA (US); Kurt Westbrook, Cogan Station, PA (US); Jason Gottschall, South Williamsport, PA (US)

(21) Appl. No.: 17/273,178

(22) PCT Filed: Sep. 4, 2019
(86) PCT No.: PCT/US19/49413

§ 371 Date: Mar. 3, 2021

Related U.S. Application Data
(60) Provisional application No. 62/726,484, filed on Sep. 4, 2018.

(51) Int. Cl. A47L 9/12; B01D 46/42; B01D 46/00; A47L 9/28

(52) U.S. Cl. CPC A47L 9/127; A47L 9/2889; B01D 46/0005; B01D 46/4227

(57) ABSTRACT

A filter for a vacuum cleaner includes a top having an open center, a bottom plate having an aperture, a center, an inside surface facing towards the top, an outside surface facing away from the top, and a catch configured to pass-through the aperture, filter material being secured between the top and bottom plate. An adaptor for a filter cage or the filter cage itself includes an elevated ring that engages the catch of the filter.

### CROSS-REFERENCE TO RELATED APPLICATIONS

This application claims the benefit of U.S. Provisional Application No. 62/726,484 filed Sep. 4, 2018. The entire contents of this application is incorporated herein by reference in its entirety.

### FIELD OF THE DISCLOSURE

This application relates generally to a filter for a vacuum cleaner and, more specifically, to a filter for a vacuum cleaner having a bottom plate with an aperture to allow a catch of the filter to pass-through. An adaptor for use with the filter, as well as a vacuum cleaner in which the filter is used, are also disclosed.

### BACKGROUND

Tank-type vacuum cleaners routinely include a tank having a dirty air inlet and a motor housing comprising a motor and a clean air outlet. In order to clean the air as it travels between the dirty air inlet and the clean air outlet, a filter is provided between the dirty air inlet and the clean air outlet. In some vacuums, a filter cage includes a float valve (such as a ball valve or cup valve) and also serves as way to hold a filter in place as it extends into the bottom of the tank. The filter is usually secured around the filter cage. Improved methods of securing the filter to the filter cage are desirable.

### SUMMARY

According to some aspects of the disclosure, a filter for a vacuum cleaner includes a top having an open center. The filter further includes a bottom plate having an outermost edge, a center, an inside surface facing towards the top and an outside surface facing away from the top, an aperture between the outermost edge and the center, and a catch movable between a first position within the aperture and a second position outside of the aperture. The filter further includes filter material secured between the top and the bottom plate. According to other aspects of the disclosure, an adaptor for a filter cage includes an annular surface having an outer circumference and an inner circumference, snaps distributed around the outer circumference of the annular surface, an elevated ring extending around the inner circumference of the annular surface, and a hook provided on the elevated ring. According to yet other aspects of the disclosure, a vacuum cleaner includes a tank including a dirty air inlet, a motor housing comprising a motor, a filter cage having an end, and a dirty air outlet, with an elevated ring on the end of filter cage, and a hook provided on the elevated ring.

In some arrangements of the filter, a handle may be hinged to the outside surface of the plate. The handle may be located adjacent to the center of the plate. The catch may be provided on the handle. The bottom plate may have a depressed center area at the center, a raised ring may be adjacent the depressed center area, and the aperture may be provided in the raised ring. The handle may be hinged to the raised ring, and the catch may be provided on the handle. The handle may have a width less than or equal to an amount that the bottom plate is depressed from the raised ring, and the depressed center area and the aperture together may have an outer perimeter at least partially complementary to the shape of the handle.

In some arrangements of the filter, the top may have an outer edge and a width between the outer edge and the open center, the bottom plate may have an outer ring extending inward from the outermost edge a distance equal to the width of the top, and the filter material may be secured between the top and the outer ring of the bottom plate. The bottom plate may further include a depressed ring adjacent to the outer ring and extending inward from the outer ring. A raised ring may be adjacent to the depressed ring, may be raised relative to the depressed ring, and may extend inward from the depressed ring. The aperture may be provided in the raised ring. The bottom plate may further include alignment channels from the inside surface to the outside surface.

In some arrangements of the adaptor, the elevated ring may have alignment ribs on an inner surface. The elevated ring may be integral with the end of the filter cage in some arrangements. In other arrangements, the elevated ring may be provided on adapter secured to the end of the filter cage.

In some arrangements of the vacuum cleaner, the filter may surround the filter cage. The filter may have a bottom plate with an aperture and a catch movable between a first position within the aperture and a second position outside of the aperture. The catch may engage the hook in the first position. The elevated ring may have alignment ribs on an inner surface, the bottom plate may have alignment channels, and the alignment ribs may be inserted into the alignment channels.

### BRIEF DESCRIPTION OF THE DRAWINGS

FIG. 1 is a bottom isometric view of a filter of the present disclosure;

FIG. 2 is a bottom view of the filter depicted in FIG. 1;

FIG. 3 is a side view of the filter depicted in FIGS. 1 and 2;

FIG. 4 is a top view of the filter depicted in FIGS. 1-3;

FIG. 5 is a top isometric view of the filter depicted FIGS. 1-4;

FIG. 6 is a top isometric view of an adaptor of the present disclosure;

FIG. 7 is a top view of the adaptor depicted in FIG. 6;

FIG. 8 is a side view of the adaptor depicted in FIGS. 6-7;

FIG. 9 is a bottom view of the adaptor depicted in FIGS. 6-8;

FIG. 10 is a bottom isometric view of a lid of a vacuum cleaner with an adaptor being installed on an end of a filter cage of the motor housing;

FIG. 11 is a bottom isometric view of the motor housing depicted in FIG. 10 with the adaptor secured to the end of the filter cage;

FIG. 12A is a bottom view of the lid depicted in FIG. 11 with the adaptor secured to the end of the filter cage;

FIG. 12B is a cross-sectional view of the filter cage and adaptor depicted in FIG. 12A along the line A-A;

FIG. 12C is an enlarged view of the filter cage and adaptor depicted in FIG. 12B showing the snaps, elevated ring, and hook of the adaptor;

FIG. 13 is a bottom isometric view of a filter being installed on the filter cage and adaptor of FIGS. 11-12C;

FIG. 14 is a bottom isometric view of the lid, adaptor, and filter of FIG. 13 with the filter secured to the adaptor;

FIG. 15A is a bottom view of the lid, adaptor, and filter of FIGS. 13 and 14 just prior to the filter being secured to the adaptor;

FIG. 15B is a cross-sectional view of the lid, adaptor, and filter of FIG. 15A along the line C-C;

FIG. 15C is an enlarged view of the filter cage, adaptor, and filter depicted in FIG. 15B showing the catch sliding along the upper surface of the hook of the elevated ring of the adaptor just prior to securing the filter to the adaptor;

FIG. 16A is a bottom view of the lid, adaptor, and filter of FIGS. 13-15C after the filter is secured to the adaptor;

FIG. 16B is a cross-sectional view of the lid, adaptor, and filter of FIG. 16A along the line C1-C1;

FIG. 16C is an enlarged view of the filter cage, adaptor, and filter depicted in FIG. 16B showing the mating face of the catch engaged with the mating end of the hook; and

FIG. 17 is a top view of a vacuum cleaner incorporating the filter and adaptor of the present disclosure; and

FIG. 18 is a cross-sectional view of the vacuum cleaner of FIG. 17 along line A-A.

### DETAILED DESCRIPTION OF THE DRAWINGS

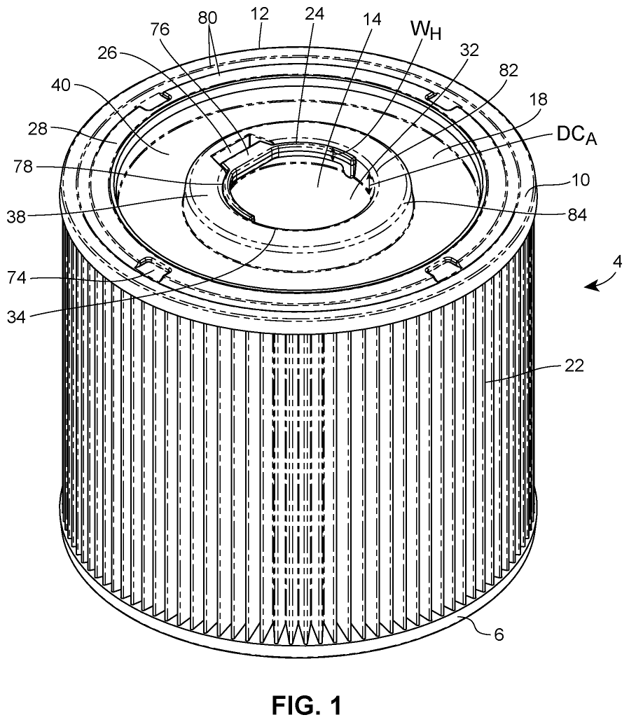

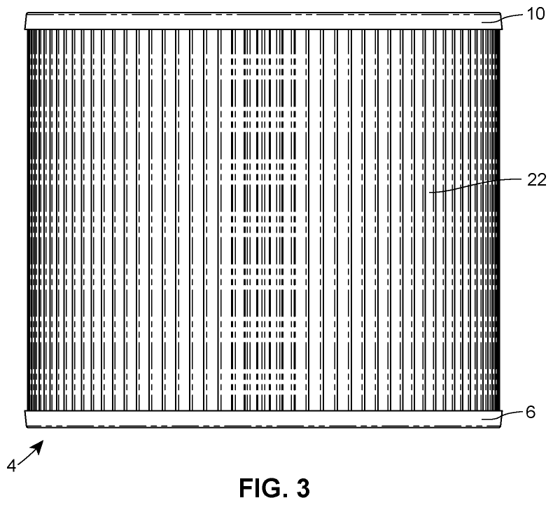

Referring now to the exemplary arrangement of a filter 4 shown in FIGS. 1-5, the filter 4 includes a top 6, a bottom plate 10, and filter material 22 secured between the top 6 and the bottom plate 10. The filter 4 has a generally cylindrical shape. The bottom plate 10 may be formed from rubber, hard plastic, metal, or another suitable material. The top 6 can be formed of similar materials, but generally will need to have some flexibility in order to provide good sealing engagement when in place on a vacuum cleaner. The filter material 22 may include any standard industrial filter material, such as a synthetic material, cloth, paper, or foam. The filter material 22 may employ a standard filtration material, a HEPA filtration material, an S-class filtration material, or activated charcoal filtration, among other options.

The top 6 and the bottom plate 10 are generally aligned with one another. In the arrangements depicted in FIGS. 1-5, the top 6 and the bottom plate 10 are the same size. In other arrangements not herein depicted, variations in the size and shape of the top 6 and the bottom plate 10 are permissible. For example, in some arrangements, the filter 4 may have a partially conical shape instead of a cylindrical shape. In such an arrangement, the bottom plate 10 may be bigger than the top 6, and the filter material 22 may be arranged at an angle from the bottom plate 10 to the top 6. In other arrangements, the top 6 and the bottom plate 10 may be different sizes, but the filter material 22 may still be arranged vertically between the bottom plate 10 and the top 6 such that the larger of the bottom plate 10 and the top 6 has an overhang outside the connection to the filter material 22.

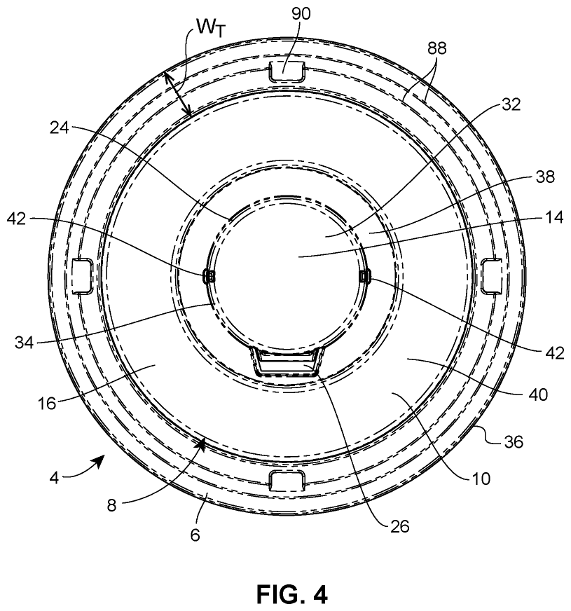

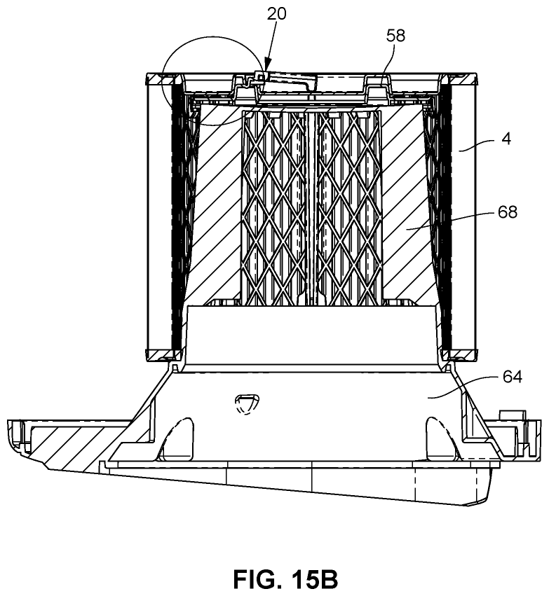

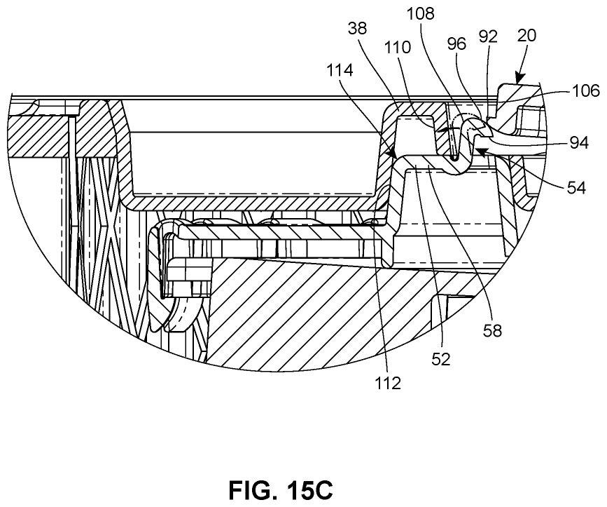

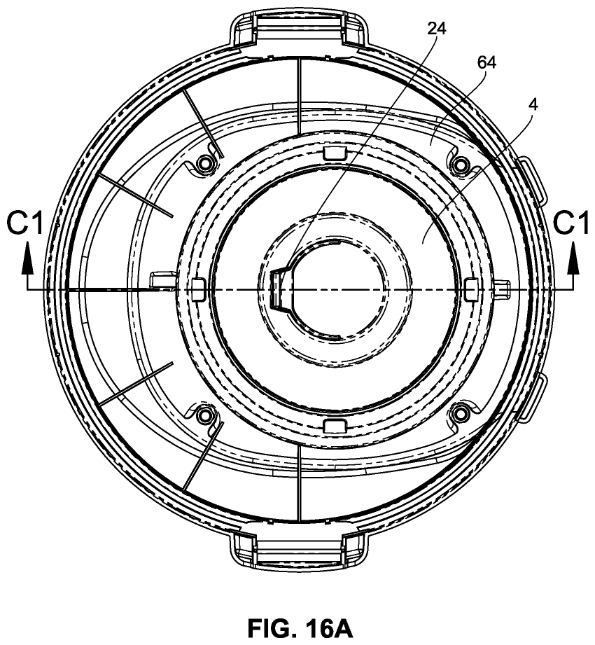

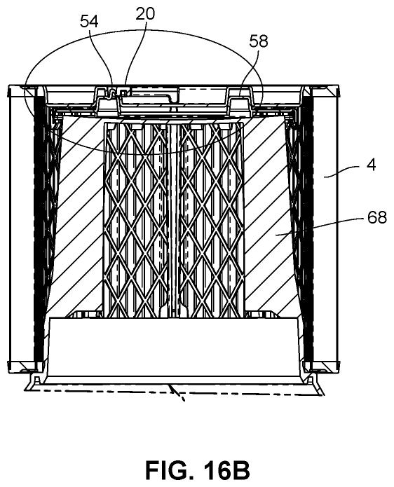

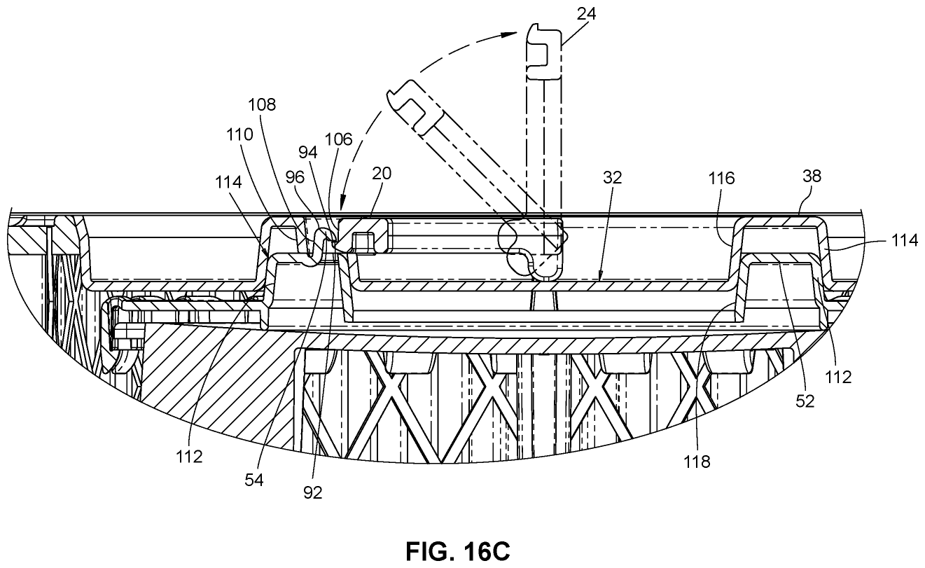

The top 6 includes an open center 8, shown in FIG. 4. The bottom plate 10 has an outermost edge 12 and a center 14, as shown in FIG. 1. As shown in FIG. 4, an inside surface 16 of the bottom plate 10 faces toward the top 6, and as shown in FIG. 1, an outside surface 18 of the bottom plate 10 faces away from the top 6. The bottom plate 10 includes an aperture 26. A catch 20 is provided on the rotatable handle 24, as best shown in FIGS. 15C and 16C. The catch 20 is movable between a first position within the aperture 26 and a second position outside of the aperture 26 as best shown in FIG. 16C.

The catch 20 is designed to flex and/or shift when contacted, and the dimensions of the catch 20, and its related clearances, in conjunction with the material chosen for the catch 20 should permit this flexing action. The catch 20 also acts to compress hook 54 when rotating into its locked position. In some arrangements, the catch 20 may be formed from a different material than the rest of the bottom plate 10 in order to facilitate the flexing action. For example, the catch 20 may be formed from a material that bends more easily or retains its shape better than the material used to form the bottom plate 10.

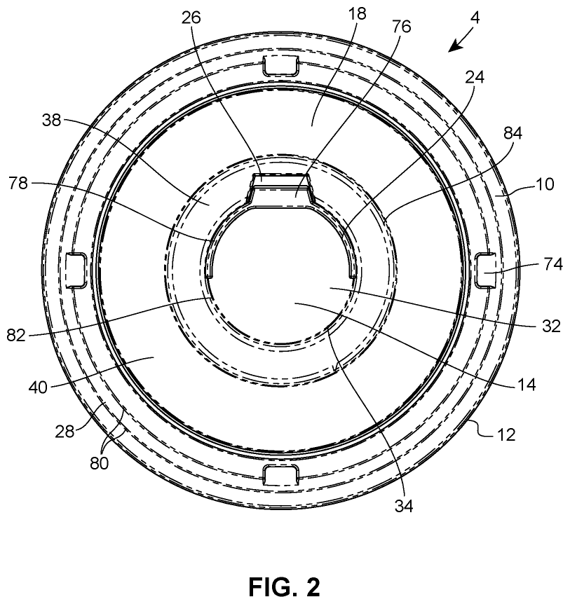

As shown in FIGS. 1 and 2, a handle 24 is hinged to the outside surface 18 of the bottom plate 10. The handle 24 may assist a user in more easily placing the filter 4. The handle 24 can be stored during use of the vacuum cleaner 2. The handle 24 can also be used again to remove the filter 4 when the time comes to replace the filter 4. The handle 24 is particularly useful during removal of the filter 4 because the filter material 22 may be covered with dust and debris, and a user may therefore be disinclined to touch the filter material 22 during the removal process.

As shown in FIG .1, the handle 24 is located adjacent to the center 14 of the plate. The catch 20 (best shown in FIGS. 15C and 16C) is provided on the handle 24. More specifically, as shown in FIG. 1, the bottom plate 10 has a depressed center area 32 at the center 14. A raised ring 38 surrounds the depressed center area 32. The aperture 26 is provided in the raised ring 38. The handle 24 is hinged to the raised ring 38. The hinged connection may be achieved using any typical hinge mechanism either with or without the use of a standard fastener.

As shown in FIG. 1, the handle 24 has a width W_{H} that is less than or equal to a distance D_{CA} that the depressed center area 32 is depressed from the raised ring 38. The depressed center area 32 has an outer perimeter 34 that is at least partially complementary to the shape of the handle 24. As a result, the handle 24 can be folded flat to lie within the depressed center area 32 without protruding above the raised ring 38 of the bottom plate 10. In some arrangements not herein depicted, in addition to the catch 20, a securement mechanism such as a latch or a clip may be provided to secure the handle 24 in the folded position. In other arrangements, the handle 24 may have a friction fit within the outer perimeter 34 or via the hinged connection with the raised ring 38 that assists with keeping the handle 24 in a folded position.

As shown in FIG .1, the handle 24 may have a shape that includes a handle arc 78 and a handle protrusion 76. The handle arc 78 may curve from the hinged connection with the raised ring 38 to the protrusion 76. The handle arc 78 may be nearly circular, nearly square, or any preferred curvature. The protrusion 76 may have space for a brand name or trademark to be displayed. The brand name or trademark may be painted on the protrusion 76, may be embossed on the protrusion 76, or may be displayed in another manner. The protrusion 76 may be circular, square, or any other desired shape. The protrusion 76 may be centered in the handle arc 78 such that the handle 24 is symmetrical. The catch 20 (best shown in FIGS. 15C and 16C) may be connected to the protrusion 76. The protrusion 76 may partially, but not fully, cover the aperture 26 when the catch 20 is in the first position within the aperture 26.

As shown in FIG. 1, the perimeter 34 is at least partially complementary to the shape of the handle arc 78 and the protrusion 76 such that the handle 24 can fold down flat within the perimeter 34. In some embodiments, the perimeter 34 is complementary to the shape of the handle 24 only in one direction, such that the handle 24 may only be folded flat within the depressed center area 32 one way. In other embodiments, the perimeter 34 is complementary to the shape of the handle in two directions, such that the handle may be folded flat within the depressed center area 32 in two ways. The depth of the depressed center area 32 may be complementary to the respective widths of the handle arc 78 and handle protrusion 76 so as to ensure a snug fit of the handle 24 in the depressed center area 32. A slanted surface 82 may be provided at the perimeter 34 so that, if the handle 24 bumps against the perimeter 34, the slanted surface 82 will help guide the handle 24 down to the depressed center area 32.

As shown in FIG. 4, the top 6 has an outer edge 36 and a width W_{T} between the outer edge 36 and the open center 8. An annular groove 88 may be provided in the top 6, as shown in FIG. 4. The annular groove 88 establishes different elevation levels for the filter media 22 to rest upon during manufacturing. This ensures that the filter media 22 has a sub-flush condition relative to at least some portions of the top 6.

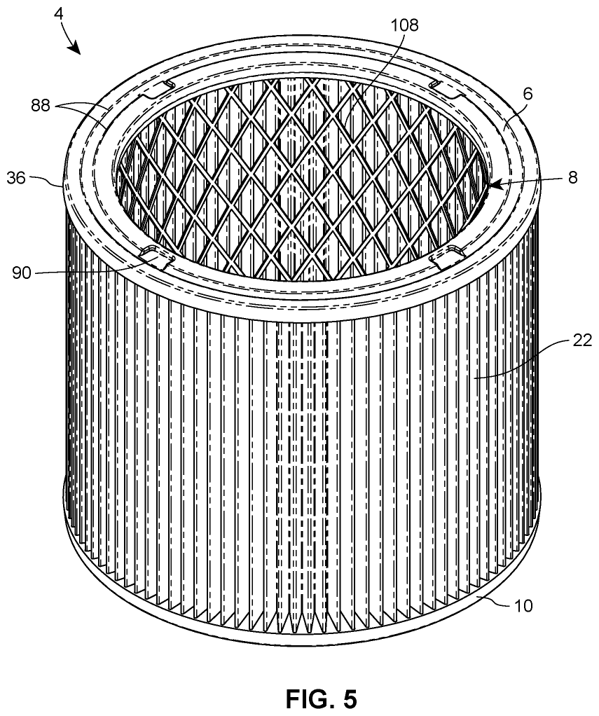

As also shown in FIG. 4, standoffs 90 may be provided in the top 6. The standoffs 90 position the cylindrical support cage 108 (shown in FIG. 5), which may be formed from metal or another rigid material, at an elevation deliberately sub-flush relative to at least some portions of the top 6. The sub-flush condition avoids undesirable handling issues for the user and assures that the top 6 has optimum sealing potential.

FIGS. 1, 2 and 4 show the topography of the bottom plate 10. The bottom plate 10 has an outer ring 28 (shown in FIG. 2) extending inward from the outermost edge 12 of the bottom plate 10 a distance equal to the width W_{T} of the top 6 (shown in FIG. 4). The filter material 22 is secured between the top 6 and the outer ring 28 of the bottom plate 10. As shown in FIG. 1, the bottom plate 10 has a depressed ring 40 adjacent to the outer ring 28 and extending inward from the outer ring 28. The raised ring 38, discussed above, is provided between the outermost edge 12 and the center 14. Specifically, the raised ring 38 is adjacent to the depressed ring 40. The raised ring 38 is raised relative to the depressed ring 40 and extends inward from the depressed ring 40. The aperture 26 is provided in the raised ring 38.

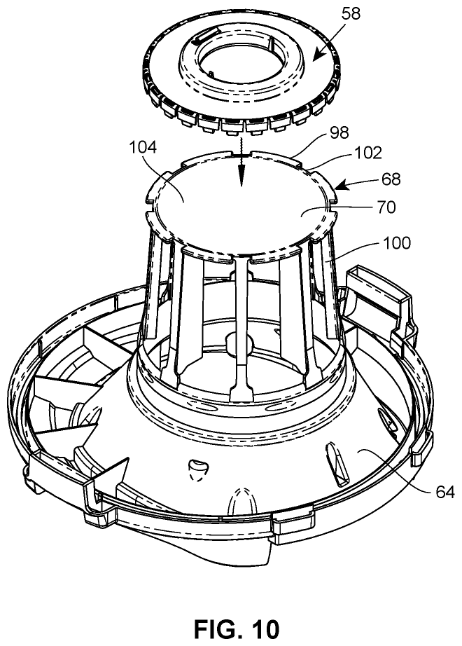

The relative positioning of the outer ring 28, depressed ring 40, raised ring 38, and depressed center area 32 may vary. For example, the outer ring 28 and the raised ring 38 may be at the same relative height. Similarly, the depressed ring 40 and the depressed center area 32 may be at the same relative height. Alternately, the outer ring 28 may be higher than the raised ring 38, or the raised ring 38 may be higher than the outer ring 28. Likewise, the depressed ring 40 may be higher than the depressed center area 32, or the depressed center area 32 may be higher than the depressed ring 40. In some arrangements, the best relative positioning is determined by the configuration of the adaptor 58, the filter cage 68, and/or the lidcage 64 (shown in FIG. 10). The outer ring 28, depressed ring 40, and/or raised ring 38 may also have surfaces that are slanted or sloped relative to horizontal or to one another. For example, the raised ring 38 may have a sloped surface 84 as shown in FIG. 1.

As shown in FIG. 2, an annular groove 80 may be provided in the outer ring 28 of the bottom plate 10. The annular groove 80 establishes different elevation levels for the filter media 22 to rest upon during manufacturing. This ensures that the filter media 22 has a sub-flush condition relative to at least some portions of the bottom plate 10.

As also shown in FIG. 2, standoffs 74 may be provided in the outer ring 28 of the bottom plate 10. The standoffs 74 position the cylindrical support cage 108 (shown in FIG. 5), which may be formed from metal or another rigid material, at an elevation deliberately sub-flush relative to at least some portions of the bottom plate 10. The sub-flush condition avoids undesirable handling issues for the user and assures that the bottom 10 has optimum sealing potential.

The bottom plate 10 may further comprise alignment channels 42, as best shown in FIG. 4. The alignment channels 42 may extend from the inside surface 16 to the outside surface 18 of the bottom plate 10. The alignment channels 42 may be used to properly align the filter 4 with respect to an adaptor 58 or a filter cage 68. The number of alignment channels 42 may be two, as pictured in FIG. 4. Alternately, the number of alignment channels 42 may be less than or more than two. The alignment channels 42 may have a uniform cross-sectional shape throughout. Alternately, the alignment channels 42 may narrow or widen along the distance from the inside surface 16 to the outside surface 18. The cross-sectional shape of the alignment channels 42 may be circular or square. Alternately, the cross-sectional shape of the alignment channels 42 may be an eclectic shape and/or may change along the distance between the inside surface 16 to the outside surface 18.

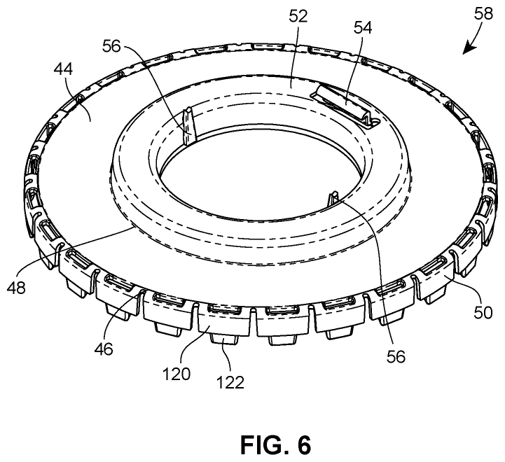

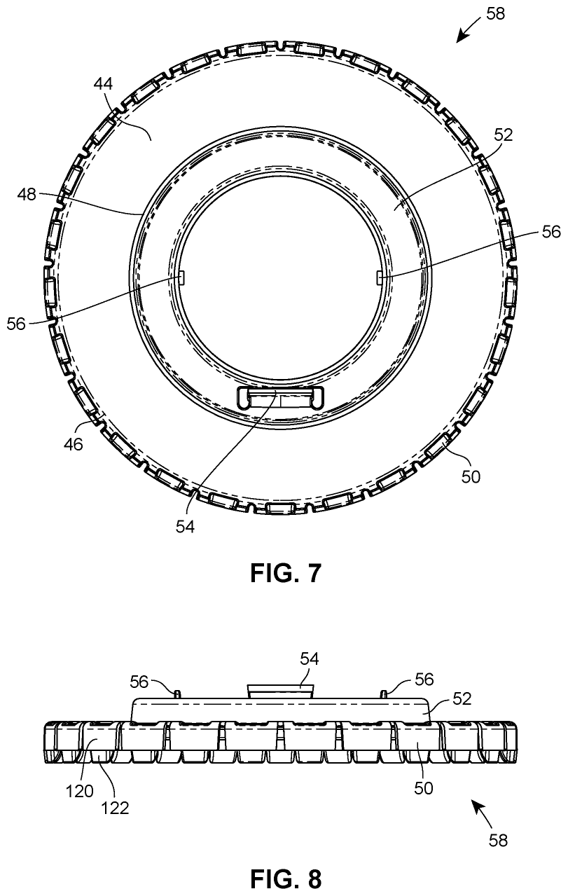

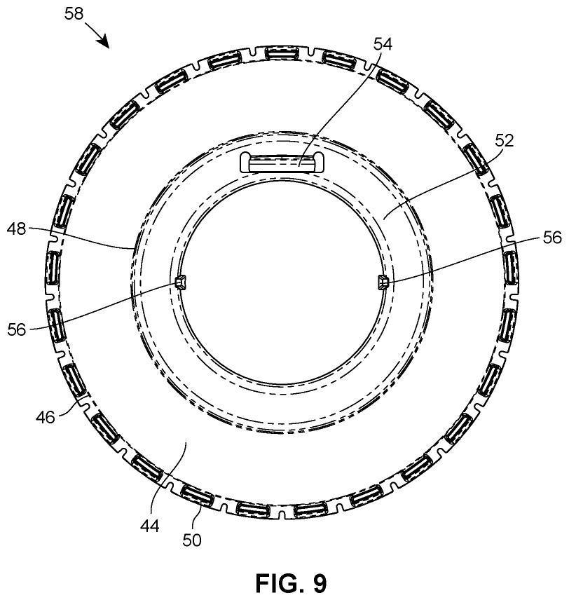

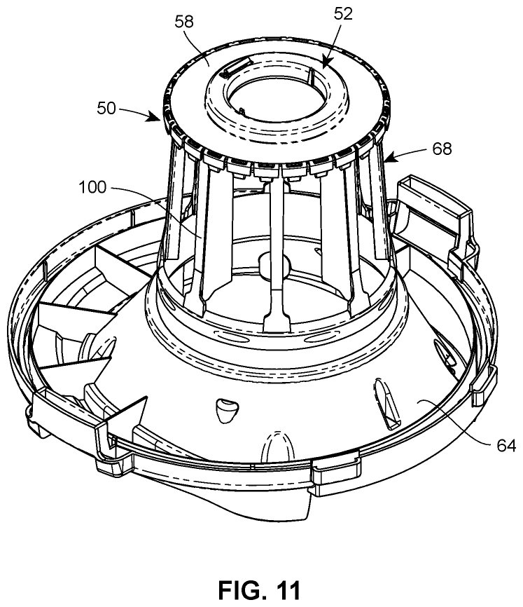

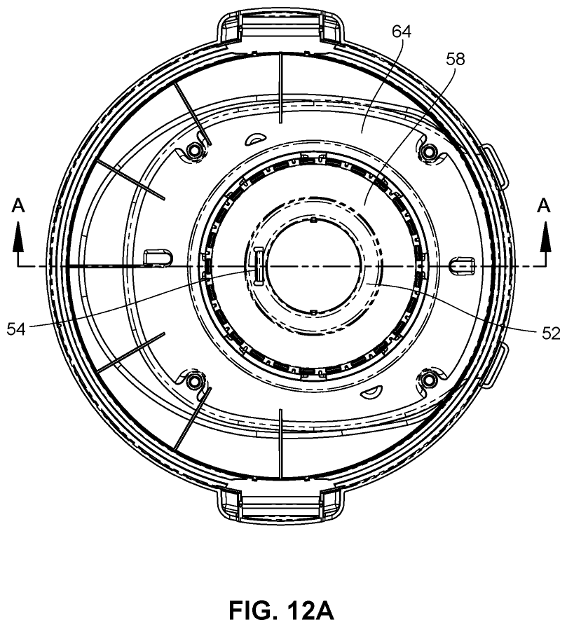

Referring now to the exemplary arrangement of an adaptor 58 best shown in FIGS. 6-12C, the adaptor 58 has an annular surface 44 having an outer circumference 46 and an inner circumference 48. Snaps 50 are distributed around the outer circumference 46 of the annular surface 44. An elevated ring 52 extends around the inner circumference 48 of the annular surface 44. A hook 54 is provided on the elevated ring.

The adaptor 58 may be formed from rubber, hard plastic, metal, or another suitable material. The hook 54 should be formed from a material having the ability to flex while still retaining its shape. In some arrangements, the hook 54 may be formed from a material that differs from that used for the rest of the adaptor 58. In other arrangements, the same material may be used for both the hook 54 and the rest of the adaptor 58.

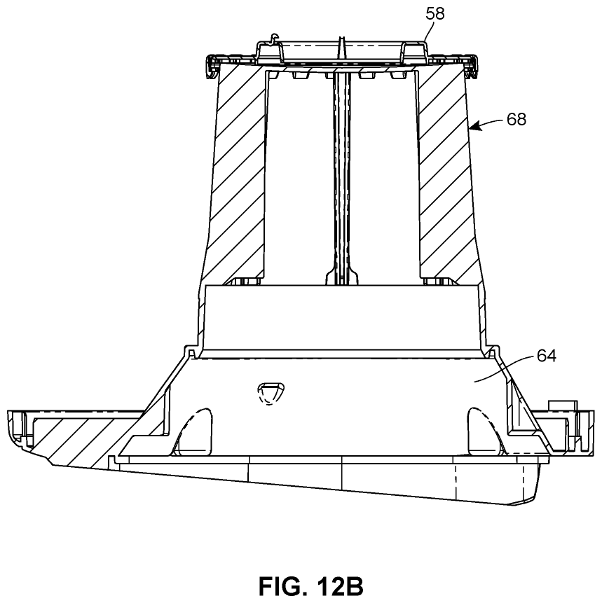

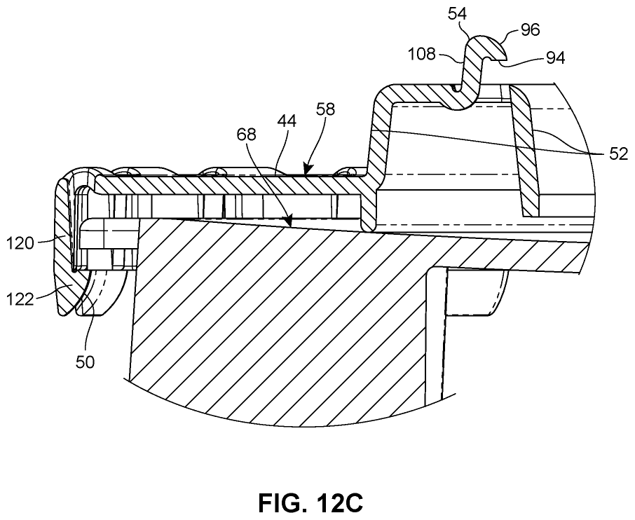

As shown best in FIG. 12C, the snaps 50 secure the adaptor 58 onto a filter cage 68 of a vacuum cleaner 2. Each snap 50 has a vertical extension 120 that allows the snap 50 to hang downward over the edge of a filter cage 68. Each snap 50 further includes a clip 122. The clip 122 engages the filter cage 68. The clip 122 may include a cut-out section, such as the 90° cut-out section shown as part of the clip 122 in FIG. 12C. Alternately, the clip 122 may have a hook-like curvature or another suitable shape that allows engagement with the filter cage 68. The number of snaps 50 distributed around the outer circumference 46 of the annular surface 44 may vary. In the arrangement shown in FIGS. 6-12C, twenty-five snaps 50 are equally distributed around the outer circumference 46. However, in other arrangements not herein depicted, the number of snaps 50 may be much lower, such as five or ten, or much higher, such as 50 or 100. In part, the number of snaps 50 may depend on the radial distance that each snap 50 covers of the outer circumference 46. Additionally, the number of snaps 50 may depend on the radial distance between each snap 50. The snaps 50 do not have to be equally distributed around the outer circumference 46. In some arrangements, two or more snaps 50 may be clustered together and spaced radially from another cluster of two or more snaps 50.

In other arrangements not herein depicted, the adaptor 58 may be connected to the filter cage 68 by means other than or in addition to the snaps 50. For example, the annular surface 44 of the adaptor 58 may be provided with an adhesive that can permanently or temporarily secure the adaptor to the filter cage 68. The adhesive might be provided on the annular surface 44 at the point of sale, and a user may simply remove an adhesive covering prior to securing the annular surface 44 to the filter cage 68. Alternately, the adhesive might be provided in a separate bottle or jar and then spread onto the annular surface 44, prior to securing the annular surface 44 to the filter cage 68. Optionally, adhesive may be provided even with an adaptor 58 that includes snaps 50.

The elevated ring 52 of the adaptor 58 includes alignment ribs 56, as best shown in FIG. 6. The alignment ribs 56 are inserted into the alignment channels 42 of the bottom plate 10 in order to properly align the filter 4 with respect to the adaptor 58. The number of alignment ribs 56 may be two, as pictured in FIG. 6. Alternately, the number of alignment ribs 56 may be less than or more than two. The alignment ribs 56 may have a uniform cross-sectional shape throughout. Alternately, the alignment ribs 56 may narrow or widen over the length of the alignment ribs 56. The cross-sectional shape of the alignment ribs 56 may be circular or square. Alternately, the cross-sectional shape of the alignment ribs 56 may be an eclectic shape and/or may change over the length of the alignment ribs 56.

As best shown in FIGS. 12C, 15C, and 16C, the hook 54 includes an upper surface 96 and a mating end 94. The hook 54 further includes a vertical extension 108 that adds distance between the mating end 94 and the elevated ring 52. The mating end 94 is shown as parallel to the annular surface 44 of the adaptor 58. However, in other arrangements not herein depicted, the mating end 94 may be at an angle, such as a 45° angle, relative to the annular surface 44. Alternately, instead of being at an angle, the mating end 94 may have a snap, aperture, or other means of being secured in place.

Although a single hook 54 is depicted herein, in other arrangements not depicted, multiple hooks 54 may extend from the elevated ring 52. The multiple hooks 54 may engage the catch 20 in identical or different manners. For example, in some arrangements, the catch 20 may have multiple surfaces that can be engaged by different hooks 54. In other arrangements, the catch 20 may have a single surface that can be engaged at different locations by multiple hooks 54. Moreover, multiple hooks 54 may be provided so that a single catch 20 can be engaged in a variety of positions, such as in an arrangement where a handle 24 with a catch 20 can be rotated or can be pressed downward in various radial directions. In such an arrangement, multiple apertures 26 may be provided in the bottom plate 10 to accommodate the multiple hooks 54.

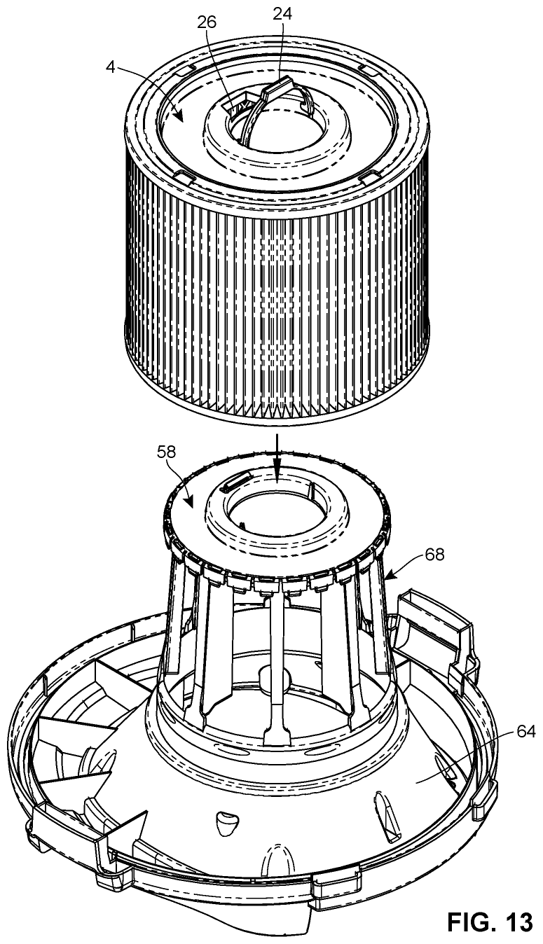

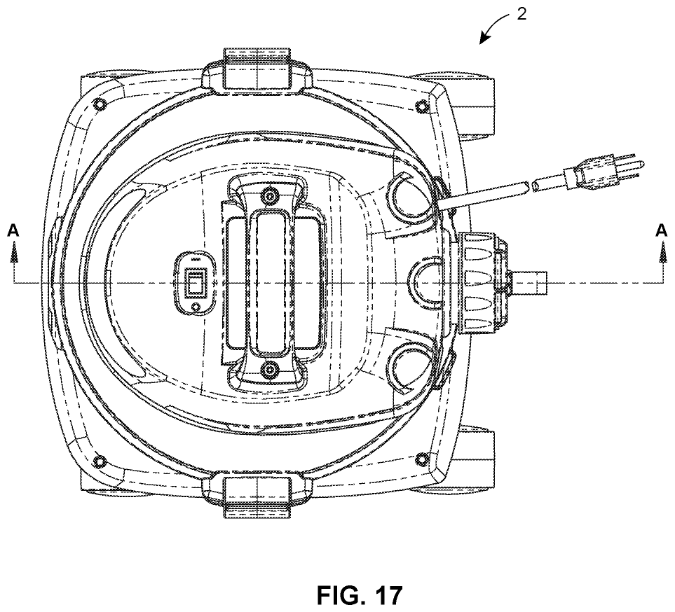

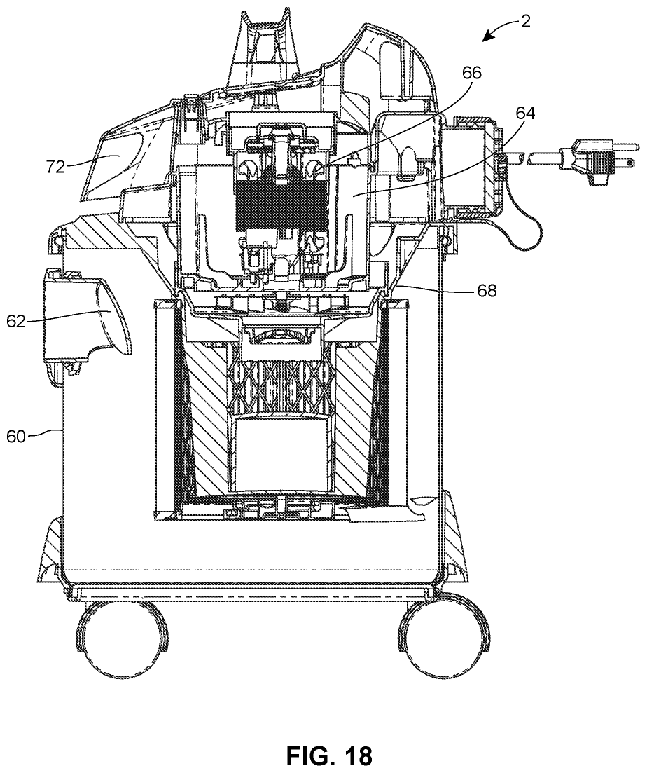

FIGS. 13-18 show the filter 4 and adaptor 58 in use on a vacuum cleaner 2. As shown in FIG. 18, the vacuum cleaner 2 includes a tank 60 having a dirty air inlet 62, a lidcage 64, a motor 66, a filter cage 68 having an end 70, and a clean air outlet 72. An elevated ring 52 is connected to the end 70 of the filter cage 68. A hook 54 is provided on the elevated ring 52.

As best shown in FIG. 10, the filter cage 68 has struts 100 that end at a round surface 104. The number of struts 100 may vary. In some arrangements, the struts 100 may extend vertically between the lidcage 64 and the round surface 104. In other arrangements, the struts 100 may be arranged at an angle, may be perforated or patterned, or may have any other structural configuration suitable to keeping the round surface 104 spaced away from the lidcage 64. The struts 100 may or may not be uniformly distributed around the round surface 104.

Projections 98 extend from the round surface 104 of the filter cage 68. Gaps 102 are provided between projections 98. The projections 98 may be uniformly distributed around the round surface 104 of the filter cage 68. Alternately, the projections 98 may be clustered in groups or may be separated by gaps 102 of differing lengths. In some arrangements, the gaps 102 are provided directly above the struts 100.

In the arrangement depicted in FIG. 10, the snaps 50 of the adaptor 58 are configured to engage the projections 98 of the filter cage 68. However, in other arrangements not herein depicted, the snaps 50 may be configured to engage the gaps 102 of the filter cage 68. In such an arrangement, the snaps 50 would be intentionally distributed on the adaptor 58 to align with the gaps 102 of the filter cage 68. The outer circumference 46 of the annular surface 44 of the adaptor 58 would be smaller than the round surface 104 of the filter cage 68.

In the arrangements depicted in FIGS. 13-18, the elevated ring 52 and hook 54 are provided on an adaptor 58 connected to the end 70 of the filter cage 68. In arrangements not herein depicted, the elevated ring 52 and hook 54 are integral with the end 70 of the filter cage 68. Specifically, the elevated ring 52 and hook 54 may be integral with the round surface 104 of the filter cage 68. Other features of the adaptor 58, such as snaps 50, would not be necessary in such an arrangement. The filter cage 68 could be formed of plastic, metal, or another suitable structural material.

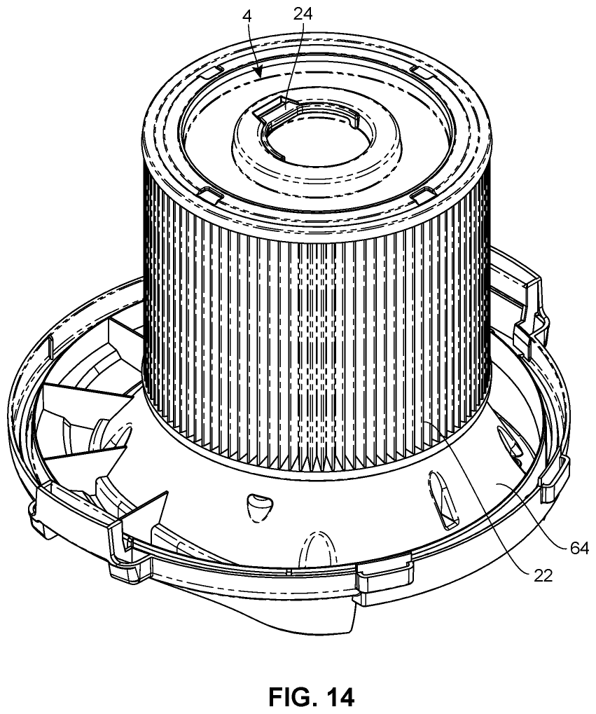

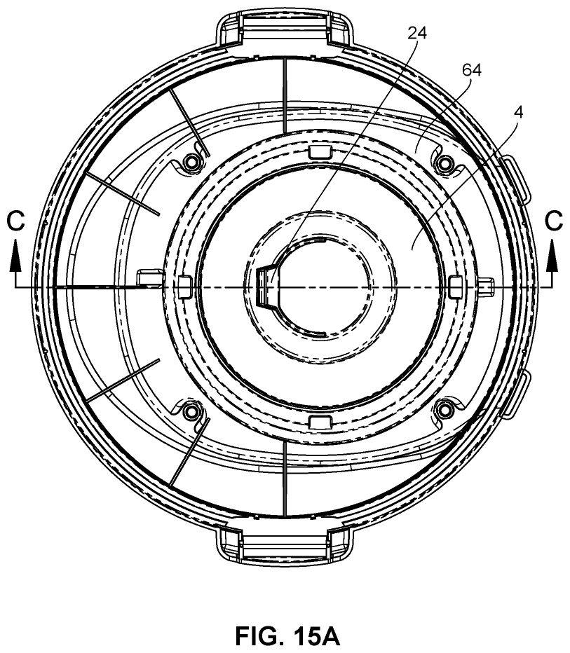

As shown in FIG. 13, the filter cage 68 and, if present, adaptor 58, are inserted into the filter 4 so that the filter 4 surrounds the filter cage 68. The catch 20 is movable between a first position within the aperture 26 of the elevated ring 52 (shown in FIG. 14) and a second position outside of the aperture 26 (shown in FIG. 16C). As shown in FIG. 15C, prior to engagement of the catch 20 of the filter 4 with the hook 54 of the adaptor 58 or filter cage 68, the hook 54 flexes via contact between the upper surface 96 of the hook 54 and the catch 20. The flexing of the hook 54 allows the catch 20 to move past the hook 54 as the filter 4 is pressed onto the filter cage 68.

Once the catch 20 is in the first position through the aperture 26 and past the hook 54, as shown in FIG. 16C, the catch 20 engages the hook 54. A vertical extension 106 of the catch 22 and the vertical extension 108 of the hook 54 facilitate the meeting of the mating face 92 of the catch 20 and the mating end 94 of the hook 54. The mating face 92 of the catch 20 engages the mating end 94 of hook 54. As shown here, the mating face 92 and the mating end 94 are horizontal. However, the mating face 92 and the mating end 94 may be connected via complementary angles. Alternately, the mating face 92 and the mating end 94 may be connected via complementary curvatures, a hook and aperture, a snap, or another means. However, the mating face 92 and the mating end 94 should be optimally designed to be easily disconnected. The filter 4 may need to be removed and replaced. Therefore, the mating face 92 and the mating end 94 should allow reverse movement whereby the hook 54is again flexed to allow the catch 20 to move past the hook 54 in the opposite direction.

A stabilizing arm 110 (best shown in FIG. 15C) of the raised ring 38 is located adjacent the aperture 26 (shown in FIG. 1). As shown in FIG. 15C, the stabilizing arm 110 presses against the adaptor 58 near the hook 54, thereby helping to stabilize the hook 54. As shown in FIG. 16C, a peripheral side 112 of the elevated ring 52 is adjacent a peripheral side 114 of the raised ring 38, and a central side 118 of the elevated ring 52 is adjacent a central side 116 of the raised ring 38 when the catch 20 is engaged with the hook 54.

1. A filter for a vacuum cleaner comprising:
a top having an open center;
a bottom plate having an outermost edge, a center, an inside surface facing towards the top and an outside surface facing away from the top, an aperture between the outermost edge and the center, and a catch movable between a first position within the aperture and a second position outside of the aperture;
filter material secured between the top and the bottom plate.

2. The filter of claim 1, further comprising a handle hinged to the outside surface of the plate.

3. The filter of claim 2 wherein the handle is located adjacent to the center of the plate.

4. The filter of claim 2, wherein the catch is provided on the handle.

5. The filter of claim 1, wherein the bottom plate has a depressed center area at the center.

6. The filter of claim 5, wherein a raised ring is adjacent the depressed center area, and the aperture is provided in the raised ring.

7. The filter of claim 6, wherein the handle is hinged to the raised ring, and wherein the catch is provided on the handle.

8. The filter of claim 7, wherein the handle has a width less than or equal to an amount that the bottom plate is depressed from the raised ring, and wherein the depressed center area and the aperture together have an outer perimeter at least partially complementary to the shape of the handle.

9. The filter of claim 1,
wherein the top has an outer edge and a width between the outer edge and the open center;
wherein the bottom plate has an outer ring extending inward from the outermost edge a distance equal to the width of the top; and
wherein the filter material is secured between the top and the outer ring of the bottom plate.

10. The filter of claim 9,
wherein the bottom plate further comprises a depressed ring adjacent to the outer ring and extending inward from the outer ring;
wherein a raised ring is adjacent to the depressed ring, is raised relative to the depressed ring, and extends inward from the depressed ring; and
wherein the aperture is provided in the raised ring.

11. The filter of claim 1, wherein the bottom plate further comprises alignment channels from the inside surface to the outside surface.

12. An adaptor for a filter cage comprising:
an annular surface having an outer circumference and an inner circumference;
snaps distributed around the outer circumference of the annular surface;
an elevated ring extending around the inner circumference of the annular surface; and
a hook provided on the elevated ring.

13. The adaptor of claim 12, wherein the elevated ring has alignment ribs on an inner surface.

14. A vacuum cleaner, the vacuum cleaner comprising:
a tank including a dirty air inlet;
a motor housing comprising a motor, a filter cage having an end, and a dirty air outlet;
an elevated ring on the end of filter cage; and
a hook provided on the elevated ring.

15. The vacuum cleaner of claim 14, wherein the elevated ring is integral with the end of the filter cage.

16. The vacuum cleaner of claim 14, wherein the elevated ring is provided on adapter secured to the end of the filter cage.

17. The vacuum cleaner of claim 14, further comprising a filter surrounding the filter cage, the filter having a bottom plate with an aperture and a catch movable between a first position within the aperture and a second position outside of the aperture.

18. The vacuum cleaner of claim 17, wherein the catch engages the hook in the first position.

19. The vacuum cleaner of claim 17,
wherein the elevated ring has alignment ribs on an inner surface;
wherein the bottom plate has alignment channels; and
wherein the alignment ribs are inserted into the alignment channels.
